(19) United States
(12) Patent Application Publication
(10) Pub. No.: US 2010/0289280 A1
(43) Pub. Date: Nov. 18, 2010

(54) METHOD AND APPARATUS FOR A DOOR STOP

(76) Inventor: Robert Nadrowski, Hopatcong, NJ (US)

Correspondence Address: WALTER J. TENCZA JR., 100 Menlo Park, Suite 210, Edison, NJ, 08837, US

(21) Appl. No.: 12/705,756

(22) Filed: Feb. 15, 2010

Related U.S. Application Data
(60) Provisional application No. 61/216,154, filed on May 15, 2009.

(51) Int. Cl. E05C 17/54

(52) U.S. Cl. 292/343

(57) ABSTRACT

A door stop including a first section, and a second section. The first section includes a plurality of stairs. The first section is connected to the second section. The first section may be at a first angle with respect to the second section in a non-compressed state. The first section may be connected to the second section in a manner, so that when a force is applied to the second section, the first section and the second section pivot with respect to each other, so that in a first compressed state with the force applied, the first section and the second section are at a second angle with respect to each other which is substantially different from the first angle. The door stop may be inserted inside a gap between a bottom of a door and a top of a floor surface, while the force is applied.

### CROSS REFERENCE TO RELATED APPLICATION(S)

This application claims the priority of U.S. Provisional Patent Application Ser. No. 61/216,154, titled “DOORABLE DOOR STOP”, filed on May 15, 2009.

### FIELD OF THE INVENTION

This invention relates to improved methods and apparatus concerning door stops.

### BACKGROUND OF THE INVENTION

There are various devices known in the prior art for door stops. Door stops keep a self closing door open so that a person can walk through a doorway, such as while carrying items, without holding the door. Prior door stops or door wedges are difficult to remove once they are placed or wedged under a door between the door bottom and a floor.

### SUMMARY OF THE INVENTION

In at least one embodiment of the present invention an apparatus is provided comprising a door stop. The door stop may include a first section, and a second section. The first section may include a plurality of stairs. The first section is connected to the second section. The first section may be at a first angle with respect to the second section in a non-compressed state. The first section may be connected to the second section in a manner, so that when a force is applied to the second section, the first section and the second section pivot with respect to each other, so that in a first compressed state with the force applied, the first section and the second section are at a second angle with respect to each other which is substantially different from the first angle.

The door stop may be further comprised of a third section, wherein the second section is connected to the third section. The third section or base section may remain in substantially the same orientation and the same position during both the non-compressed state and the first compressed state. The door stop may be further comprised of a fourth section. The fourth section may be fixed to the second section, so that the fourth section pivots with the second section when the force is applied. The fourth section may be raised above the second section. The fourth section may include a top surface with a plurality of ridges.

Each of the plurality of stairs of the first section may include a top surface with a plurality of ridges. The first angle, of the first section with the second section, may be less than one hundred and eighty degrees, such as about one hundred and thirty-five degrees, and the first angle may be an interior angle of the door stop. The second angle may be approximately one hundred and eighty degrees. The door stop may be made of a flexible material.

In at least one embodiment of the present invention, a method is provided, which may include applying a first force to a second section of a door stop, and inserting the door stop inside a gap between a bottom of a door and a top of a floor surface, while the first force is applied. The door stop may be configured as previously specified. The method may further include ceasing to apply the first force to the second section, while at least part of the first section is inside of the gap, and after ceasing to apply the first force to the second section, waiting for a period of time and during the period of time allowing at least a portion of the first section to remain inside of the gap. During the period of time, the door stop prevents or substantially prevents the door from moving. After the period of time, the method may include, applying a second force to the second section and simultaneously removing the door stop, so that no part of the door stop is inside of the gap. With no part of the door stop inside of the gap, the door can move freely.

### BRIEF DESCRIPTION OF THE DRAWINGS

FIG. 1 shows a top front right side perspective view of a door stop in accordance with an embodiment of the present invention;

FIG. 2 shows a bottom left side perspective view of the door stop of FIG. 1;

FIG. 3 shows a right side planar view of the door stop of FIG. 1;

FIG. 4 shows a left side planar view of the door stop of FIG. 1;

FIG. 5 shows a top side planar view of the door stop of FIG. 1;

FIG. 6 shows a bottom side planar view of the door stop of FIG. 1;

FIG. 7 shows a front planar view of the door stop of FIG. 1;

FIG. 8 shows a rear planar view of the door stop of FIG. 1;

FIG. 9A shows a method of use of the door stop of FIG. 1 in a first state where the door stop is not compressed, deformed, or bent; and

FIG. 9B shows a method of use of the door stop of FIG. 1 in a second state where the door stop is in a first partial state of compression, deformation, or is bent to some to a first partial extent.

### DETAILED DESCRIPTION OF THE DRAWINGS

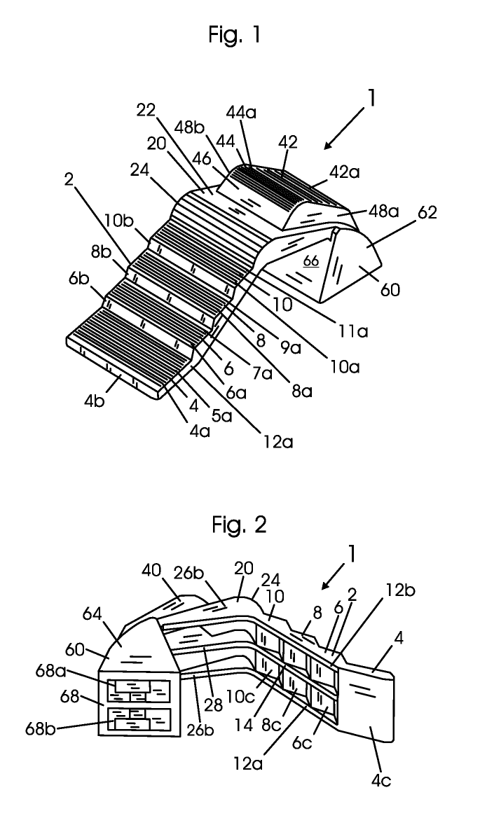

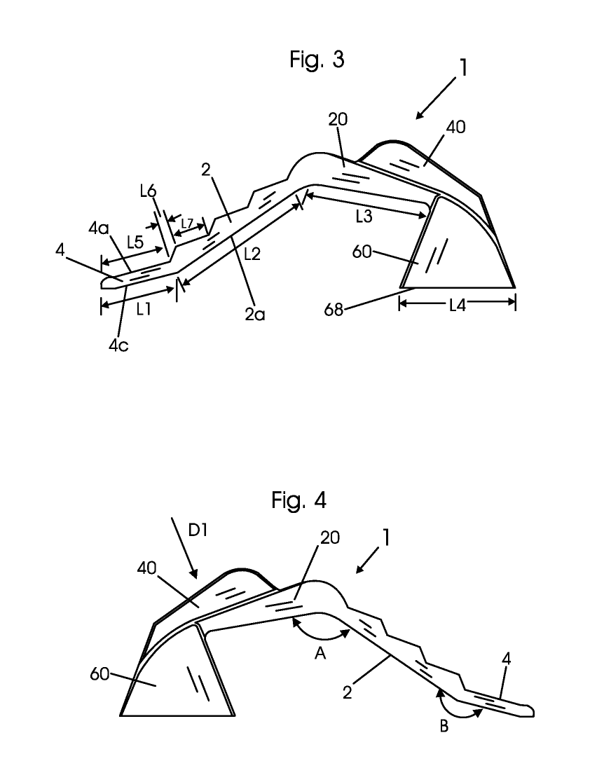

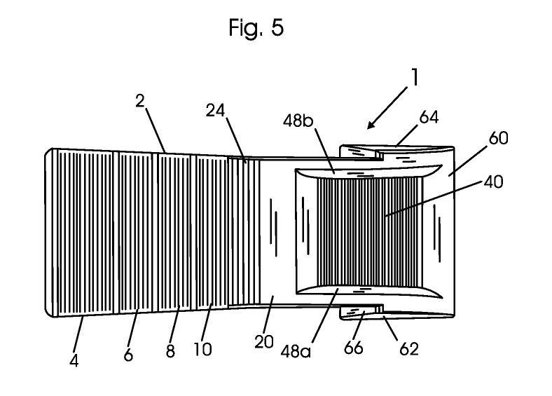

FIG. 1 shows a top front right side perspective view of a door stop 1 in accordance with an embodiment of the present invention. FIG. 2 shows a bottom left side perspective view of the door stop 1. FIGS. 3-8 show right side, left side, top side, bottom, front, and rear planar views of the door stop 1, respectively.

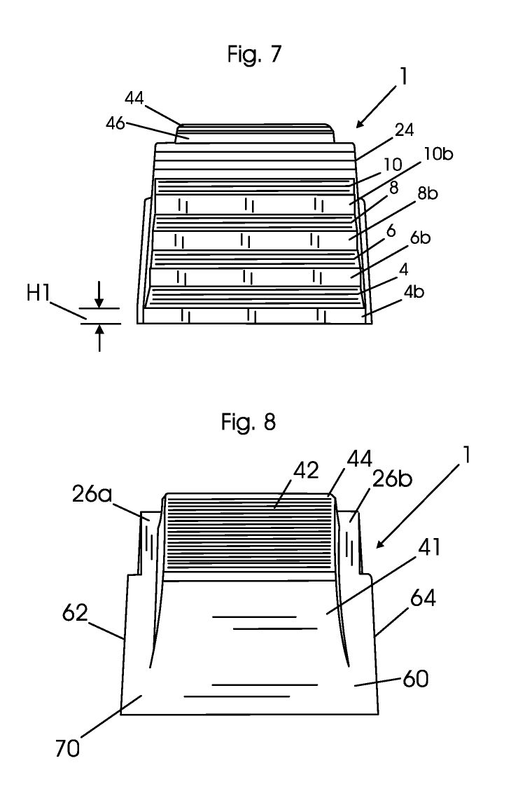

Referring to FIGS. 1-8 the door stop 1 includes section 2, 4, 20, 40, and 60. The section 2 includes stairs 6, 8, and 10 as shown in FIG. 1. The section 4 is a first stair. Section 4 is at an interior angle B of more than one hundred and eighty degrees, as shown in FIG. 4 with respect to the section 2. Stairs 4, 6, 8, and 10 have horizontal top members and/or surfaces 4a, 6a, 8a, and 10a on which are located pluralities of ridges 5a, 7a, 9a, and 11a, respectively. Stairs 4, 6, 8, and 10 have vertical members and/or surfaces 4b, 6b, 8b, and 10b, respectively, each of which may have a height of H1, shown in FIG. 7, which may be about one eighth of an inch. The stairs 6, 8, and 10 of section 2 are fixed to and are supported by members or ribs 12a and 12b and central member or rib 14 as shown in FIG. 2. The sections 2, 20, 40, and 60 may be fixed together so that the members 12a and 12b are at an interior angle A, shown in FIG. 4, of about one hundred and thirty-five degrees with respect to section 20. The members 12a, 12b, and the central member 14 are support ribs that pick up the stress load when a force is applied to section 20, such as by stepping on section 40.

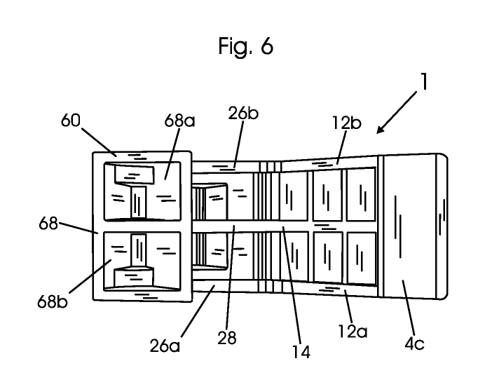

The section 20 includes a rounded portion 24, and a flat inclined portion 22 shown in FIG. 1. The rounded portion 24 may have ridges 24a. The section 40 includes an inclined portion 46, a rounded portion 44, a flat inclined portion 42 shown in FIG. 1, and a curved portion 41 shown in FIG. 8. The section 60 includes a left side 64, shown in FIG. 2, a ridge side 62, and a front side 66 shown in FIG. 1, a bottom 68 shown in FIG. 2, and a rear side 70 shown in FIG. 8. The section 60 may include indentations 68a and 68b shown in FIG. 2 and FIG. 6.

The horizontal top member or surface 4a may have a length L5 as shown in FIG. 3, which may be about one inch. The horizontal top members 6a, 8a, and 10a may also have a length of L5. The bottom surface 4c shown in FIG. 2 and FIG. 3 may have a length of L1, which may be about one and one quarter inches. The bottom surfaces 6c, 8c, and 10c, shown in FIG. 2, may also have a length of L1. The bottom surface 4c of the stair 4 may be at an interior angle B, shown in FIG. 4, of about two hundred and twenty-five degrees with respect to the section 2. The bottom surface 2a may have a length of L2 which may be three inches. The section 20 may have a length of L3 which may be two and one quarter inches. The bottom surface 68 of the section 60 may have a length of L4, which may be two and one quarter inches. Each vertical member of each of stairs 6, 8, and 10 may be angled, as shown in FIG. 3, such as an angle of about thirty degrees off of a line perpendicular to a ground surface. and may have a length of about one eighth of an inch. Each of the top horizontal members 6a, 8a, and 10a may have a length of L7, which may be about three quarters of an inch.

The door stop or apparatus 1 may be made entirely of a flexible material such as a flexible rubber, a flexible plastic, or a mixture of both.

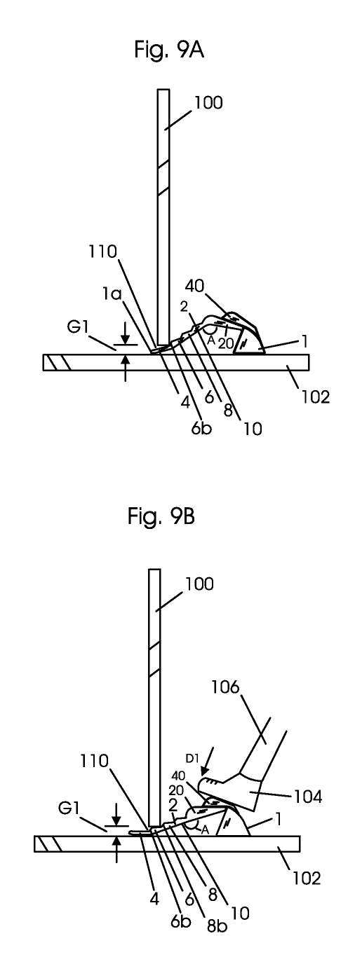

FIG. 9A shows a method of use of the door stop 1 of FIG. 1 in a first state where the door stop is not compressed, deformed, or bent. In FIG. 9A a door 100 and a floor 102 is shown. There is a gap 110 between a bottom of the door 100 and the top surface of the floor 102. A front edge 1a of the door stop 1 has been inserted through the gap 110, so that at least a portion of the door stop 1 lines inside of the gap 110. The gap 110 has a height of G1. In the non-compressed state of FIG. 9A, the door stop 1 can be inserted so that the stair 4 is inserted into the gap 110 and the door 100 abuts against the vertical member and/or surface 6b of the stair 6. Thus in the non-compressed state of FIG. 9A, the stairs 6, 8, and 10 can not fit under the gap G1 between the door 100 and the floor 102. In the non-compressed state, the section 2 (or stairs 6, 8, and 10 section) makes an interior angle A of less than 180 degrees, as shown in FIG. 4, with the section 20. This interior angle A becomes greater when a downward force D1 is applied to the section 20, by stepping on the section 40. In FIG. 9B the angle A is now approximately 180 degrees having increased from that shown in FIG. 9A.

FIG. 9B shows a method of use of the door stop 1 of FIG. 1 in a second state where the door stop is in a first partial state of compression, deformation, or is bent to some to a first partial extent. The door stop 1 can be changed from the non-compressed state of FIG. 9A to the state of partial compression of FIG. 9B by a person stepping on the section 40 with a foot 104 of the person and pressing down with the foot 104 in the direction D1. The pressing down on section 40 causes the section 2 to deform with respect to the section 20. In the partial compression state of FIG. 9B, the section 2 has been straightened with respect to the section 20. In the non-compressed state of FIG. 9A, the section 2 is at an angle of less than one hundred eighty degrees (such as one hundred and thirty five degrees) with respect to the section 20, while in the first partial compression state of FIG. 9B, the section 2 has been compressed, deformed, or bent to be aligned with the section 20, i.e. at an angle A of approximately one hundred and eighty degrees. In other embodiments, the section 2 will only be able to be compressed to a small extent, such as one inch, with respect to the section 20, and the section 2 may not be fully straightened with respect to the section 20, when the section 40 is stepped on to avoid breaking or stressing the door stop 1. In FIG. 9B, the stair 6 can now be fit in the gap 110 because of the deformation of door stop 1. The door stop 1 now slides into the gap 110 up to the vertical member 8b of the stair 8. A person cease or stop applying pressure or force with the foot 104 and leave the door stop 1 inside of the gap G1 in the state shown in FIG. 9B for a period of time. During the period of time, the door stop 1 holds the door 100 open. The door stop 1 presses against the bottom surface of the door 100 because the door stop 1 is attempting to push back into its rest state of FIG. 9A, but is prevented from doing so by the bottom surface of the door stop 100 along with the top surface of the floor 102. The remove the door stop 1 after the period of time, the individual would apply a force down in the direction D1 and simultaneously remove the door stop 1, so that no part of the door stop 1 is inside of the gap G1.

The door stop 1 is useful in at least one embodiment, for keeping an automatically closing door open, so that a person carrying items can pass through without that person holding the door. For example, the door stop 1 can keep the door 100 open, while a person walks through a doorway with furniture, tools, or other items.

The door stop 1 may be made of a flexible rubber, a flexible plastic or some mixture of flexible rubber and flexible plastic.

In at least one embodiment, the door stop 1 may be configured to work with a gap between a bottom of a door and a top floor surface of from a half inch to two and a half inches. The steps or stairs 4, 6, 8, and 10 help the door stop 1 to work with different size gaps. The door stop 1, in at least one embodiment, is configured so that the pressure from stepping down on section 40 substantially goes to the section 60 at the back or rear end of the door stop 1, and this keeps the door stop 1 from sliding.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a door stop comprising
a first section, and a
a second section,
wherein the first section includes a plurality of stairs;
wherein the first section is connected to the second section;
wherein the first section is at a first angle with respect to the second section in a non-compressed state; and
wherein the first section is connected to the second section in a manner, so that when a force is applied to the second section, the first section and the second section pivot with respect to each other, so that in a first compressed state with the force applied, the first section and the second section are at a second angle with respect to each other which is substantially different from the first angle.

2. The apparatus of claim 1 wherein
the door stop is further comprised of
a third section;
wherein the second section is connected to the third section;
and wherein the third section remains in substantially the same orientation and the same position during both the non-compressed state and the first compressed state.

3. The apparatus of claim 2 wherein
the door stop is further comprised of
a fourth section;
wherein the fourth section is fixed to the second section, so that the fourth section pivots with the second section when the force is applied;
and wherein the fourth section is raised above the second section.

4. The apparatus of claim 3 wherein
wherein the fourth section includes a top surface with a plurality of ridges.

5. The apparatus of claim 1 wherein
each of the plurality of stairs includes a top surface with a plurality of ridges.

6. The apparatus of claim 1 wherein
the first angle is less than one hundred and eighty degrees and the first angle is an interior angle of the door stop.

7. The apparatus of claim 6 wherein
the second angle is approximately one hundred and eighty degrees.

8. The apparatus of claim 1 wherein
the door stop is made of a flexible material.

9. A method comprising the steps of:
applying a first force to a second section of a door stop; and
inserting the door stop inside a gap between a bottom of a door and a top of a floor surface, while the first force is applied; and
wherein the door stop is comprised of a first section, and a second section;
wherein the first section includes a plurality of stairs;
wherein the first section is connected to the second section;
wherein the first section is at a first angle with respect to the second section in a non-compressed state; and
wherein the first section is connected to the second section in a manner, so that when the first force is applied to the second section, the first section and the second section pivot with respect to each other, so that in a first compressed state with the first force applied, the first section and the second section are at a second angle with respect to each other which is substantially different from the first angle.

10. The method of claim 9 wherein
the door stop is further comprised of
a third section;
wherein the second section is connected to the third section;
and wherein the third section remains in substantially the same orientation and the same position during both the non-compressed state and the first compressed state.

11. The method of claim 10 wherein
the door stop is further comprised of
a fourth section;
wherein the fourth section is fixed to the second section, so that the fourth section pivots with the second section when the first force is applied;
and wherein the fourth section is raised above the second section.

12. The method of claim 11 wherein
wherein the fourth section includes a top surface with a plurality of ridges.

13. The method of claim 9 wherein
each of the plurality of stairs includes a top surface with a plurality of ridges.

14. The method of claim 9 wherein
the first angle is less than one hundred and eighty degrees and the first angle is an interior angle of the door stop.

15. The method of claim 14 wherein
the second angle is approximately one hundred and eighty degrees.

16. The method of claim 9 wherein
the door stop is made of a flexible material.

17. The method of claim 9 further comprising
ceasing to apply the first force to the second section, while at least part of the first section is inside of the gap; and
after ceasing to apply the first force to the second section, waiting for a period of time and during the period of time allowing at least a portion of the first section to remain inside of the gap, and then after the period of time, applying a second force to the second section and simultaneously removing the door stop so that no part of the door stop is inside of the gap.
